(19) United States
(12) Patent Application Publication
(10) Pub. No.: US 2007/0026158 A1
(43) Pub. Date: Feb. 1, 2007

(54) Thermal spray device and methods using a preheated wire

(75) Inventors: Ronald J. Molz, Mt. Kisco, NY (US); James Weber, Bay Shore, NY (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Sulzer Metco (US) Inc.

(21) Appl. No.: 11/190,002

(22) Filed: Jul. 27, 2005

(51) Int. Cl. C23C 4/00; B05D 1/08; B05B 13/04

(52) U.S. Cl. 427/446; 118/320

(57) ABSTRACT

The present invention provides a thermal spray gun apparatus and methods that improves the operating efficiency of the thermal spray process by preheating the wire feedstock prior to the wire reaching the combustion chamber of the thermal spray gun. Methods and arrangements for preheating the feed wire prior to or after the point the wire is engaged by the spray gun's wire feeding mechanism are disclosed.

### CROSS REFERENCE TO RELATED APPLICATIONS

Not Applicable.

### STATEMENT REGARDING SPONSORED RESEARCH OR DEVELOPMENT

Not Applicable.

### REFERENCE TO SEQUENCE LISTING

Not Applicable.

### BACKGROUND OF THE INVENTION

1. Field of the Invention

The present invention relates generally to the field of flame spray methods and apparatuses. Specifically, the invention provides for improving the operation of the combustion wire thermal spray process by preheating the wire to allow increased wire feed rates and improved thermal efficiency.

2. Description of Related Art

The combustion wire thermal spray process is used in a variety of applications including, for example, corrosion protection of both structures and components and reclamation of worn shafts and other parts. The process entails feeding a wire stock material through a combustion chamber. In conventional wire gun constructions, the wire is generally fed axially through the gun at a controlled rate by a pair of feed rollers which grip the wire and rotate to push the wire through the combustion chamber, which may include a gas head nozzle arrangement and an air cap. The nozzle arrangement generally includes a ring of burner jets or other heating mechanism surrounding the wire passage through which a combustible gas mixture is passed and burned. The heat of the flame heat-softens the leading tip of the wire as the tip passes into the air cap and a high velocity stream of blast gas is directed against and impinges on the softened tip atomizing the metal (or other heat-fusible material) in the form of particles. These molten particles are propelled from the gun onto a substrate to form a coating.

The combustion process must provide sufficient heat to both raise the wire material to the melting point and also then provide the energy necessary to melt the wire. The speed at which these physical changes occur is a limiting factor in the efficiency of applying the coating. The wire feed rate and flame settings must be balanced to produce continuous melting of the wire to give a fine particulate spray. Annular compressed air flow at the air cap atomizes and accelerates the particles towards the substrate. Variables such as the diameter and material composition of the wire are some of the factors that determine the amount of energy required to accomplish both heat and melt the wire. These variables are generally predetermined by the wire material and coating requirements. However, other process variables, such as ambient temperature of the wire prior to entering the combustion chamber may also affect the amount of energy (and speed) required to transform the wire to molten particles. If the wire could be heated prior to reaching the combustion chamber then more energy would be available to melt the wire versus raising the temperature of the wire.

The benefits of preheating powders prior to injection into a plasma gun have been previously recognized. Preheating powder delivered to the gun has improved efficiency by reducing the amount of energy needed in the plasma plume to melt the powder feed stock or, alternatively, increasing the amount of powder feed stock that could be melted with a given plasma plume.

Application of the principles for preheating powders prior to injection into a plasma gun is not directly transferable to the combustion wire thermal spray process. Unlike particles, the heated wire must remains hard enough to enable the wire feeding mechanisms (e.g., feed rollers) to draw the wire through the combustion gun. Another concern is the heat loss from the wire that occurs if the wire is preheated at some point away from the spray gun combustion chamber. Typical wires such as copper or aluminum are ideal for heat loss to the environment. This heat loss limits the efficiency of the preheating process and the efficiency of the combustion process. Thus, there remains a need in the art for a combustion wire thermal spray apparatus and process that can provide improved efficiency while overcoming the above limitations.

### SUMMARY OF THE INVENTION

Accordingly, the present invention addresses the above-mentioned deficiencies in conventional thermal spray gun apparatuses by providing an apparatus and methods that improves the thermal spray process by preheating the feedstock wire prior to entry into the combustion chamber of the thermal spray gun. Preheating the feed wire for a combustion wire thermal spray process improves the operating capability of the combustion wire gun through higher feed rates and high operating efficiencies.

In one embodiment, the invention provides a method of producing a coating with a thermal spray gun including a wire feeder and a combustion chamber. The method includes the steps of providing a wire feedstock with wire of heat-fusible material, heating the wire from the wire feedstock to a temperature above ambient conditions, and using the wire feeder to feed the wire into the thermal spray gun. The method also includes the steps of feeding the heated wire into the combustion chamber to a point where the leading tip of the wire is melted and atomized such that a spray stream containing the heat-fusible material is propelled from the wire tip, and, finally, directing the spray stream toward a substrate to produce a coating thereon.

In another embodiment, the invention provides a wire combustion thermal spray gun. The gun includes a nozzle means for generating an annular heating flame, heating means for pre-heating a wire of heat-fusible material to a temperature above ambient conditions, feeding means for feeding the wire axially from the nozzle within the heating flame such that the wire is melted at a tip of the wire by the heating flame, and atomizing means for atomizing the melted material from the wire tip and propelling the atomized material in a spray stream.

Another embodiment of the invention provides a method of delivering heated wire feedstock to a combustion chamber of a thermal spray gun. The method includes the steps of providing a wire feedstock with wire of heat-fusible material, heating the wire from the wire feedstock to a temperature above ambient conditions, and using the wire feeder to feed the wire into the thermal spray gun. The method finally includes the step of feeding the heated wire into the combustion chamber.

In yet another embodiment, a wire combustion thermal spray gun system is provided. The system includes a gun body, a nozzle mounted on the gun body, an angular gas cap extending from the nozzle with a passage there through defining a combustion chamber, one or more feed rollers for receiving a leading end of a wire and feeding the leading end axially through the nozzle passage and into the combustion chamber, and a heater for raising the temperature of a portion of the wire above ambient conditions prior to the portion entering the nozzle passage.

### BRIEF DESCRIPTION OF THE DRAWINGS

The accompanying drawings are included to provide further understanding of the invention and are incorporated in and constitute a part of this specification. The accompanying drawings illustrate embodiments of the invention and together with the description serve to explain the principles of the invention. In the figures:

FIG. 1 illustrates a wire combustion gun with preheat device according to one embodiment of the invention;

FIG. 2 illustrates a wire combustion gun with preheat device according to another embodiment of the invention;

FIG. 3 illustrates a wire combustion gun with two preheat devices according to another embodiment of the invention;

FIG. 4 provides a process flow diagram of a method for applying a coating with a wire combustion gun using a preheated wire according to one embodiment of the invention; and

FIG. 5 provides a process flow diagram of a method for applying a coating with a wire combustion gun using a preheated wire according to another embodiment of the invention.

### DETAILED DESCRIPTION OF THE INVENTION

Reference will now be made in detail to the preferred embodiments of the present invention, examples of which are illustrated in the accompanying drawings.

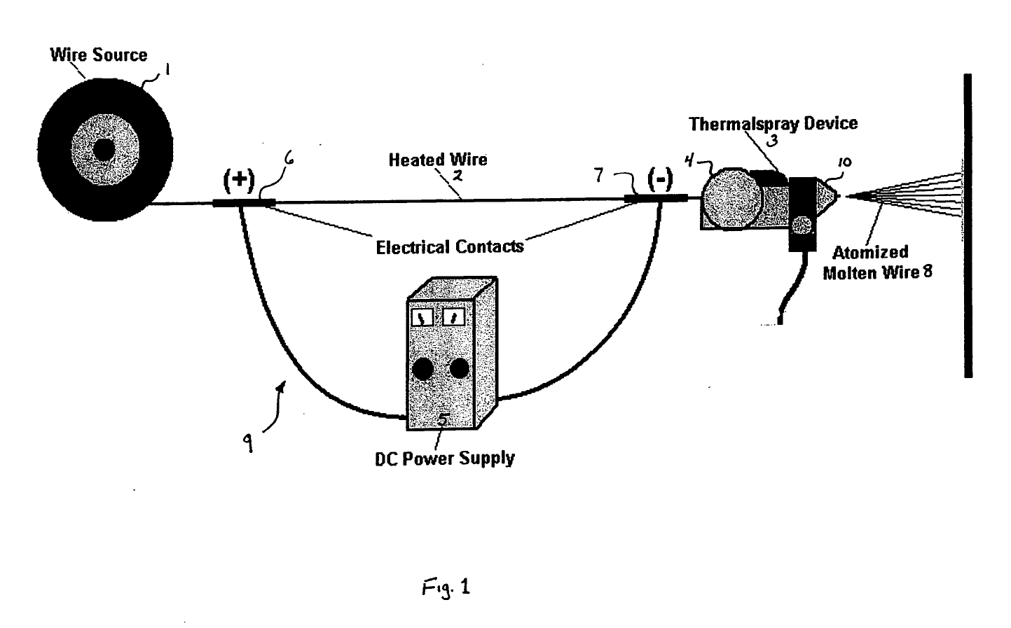

Referring to FIG. 1, a schematic of a wire combustion gun system according to one embodiment of the present invention is shown. As used herein, the term “wire” is generically used to designate both wires and rods. In general, a wire feed stock source 1 is provided from which a wire 2 is fed past a heating section 9 into a thermal spray device 3. Wire 2 may be copper, bronze, aluminum, tin, zinc, steel, or any other material suitable for processing through a combustion wire thermal spray device. The heating section 9 is shown as a resistive heating device with a power supply 5 and electrical contacts 6 and 7 touching the wire 2 at two points prior to the wire being fed into the thermal spray device 3. The heating section 9 may be a separate device between the wire feed stock source 1 and the thermal spray device 3, or the heating section 9 may be integral to the thermal spray device 3. The power source 5 may be a DC power source or any other source of energy to heat the wire known to one skilled in the art. While resistive heating may provide the highest efficiency heating, induction heating, conductive heating, radiation heating or a combination of heating methods may also be used within heating section 9.

Thermal spray device 3 contains a wire feeder 4 to receive the wire 2 and feed the wire into the combustion chamber 10 of the thermal spray device 3. (Combustion chamber 10 is generally contained within the nozzle of the thermal spray device.) Wire feeder 4 may include one or more rollers to grip and advance the wire 2. However, other conventional wire feeders known in the art may be used provided the wire feeder 4 can withstand the above-ambient wire temperatures, which may approach the melting point of the wire material. Different types of wire feeders and different wire materials will impact the determination of what operational temperatures prevent the wire from softening to the point that mechanical feeding is not feasible.

As an example of the improved efficiency resulting from the invention, the amount of heat energy required to raise the temperature of a gram of copper wire to the melting point from typical room temperature is 0.39 BTU's. The amount of energy to melt a gram of copper wire at the melting temperature is around 0.22 Btu's. Thus, if the wire feed stock can be brought to the melting point of the wire an additional 198% more wire can be melted with a given combustion parameter for the copper wire feed stock material. Similar results work out for other wire feed stock materials including Aluminum (145%), Molybdenum (227%), Tin (75%), and Zinc (152%).

Raising the feed stock temperature any appreciable amount increases the amount of wire than can be processed. Beneficial improvements can thus be realized by raising the temperature of the feed stock to points below the melting temperature. Further efficiencies from preheating can also be realized because the energy means used to heat the wire provide a more efficient energy transfer mechanism than heating the wire in the combustion flame prior to melting. The transfer of heat from a hot gas stream to a solid or liquid material in a typical thermal spray operation is typically less than 30% efficient while the direct heating by resistive or inductive means, for example, can approach 100%, assuming heat loss to the external environment is minimized.

In the configuration shown in FIG. 1, a key operational efficiency factor is ensuring that the heated wire 2 remains hard enough to facilitate wire feeder 4 to draw the wire through the thermal spray device 3. Wire feed stocks such as bronze or copper, which turn soft prior to reaching melting temperatures, are limited in how close to the melting temperature they can be preheated and still be mechanically fed through the thermal spray device. In some cases these types of wires can only be pre-heated to about half the melting temperature before becoming too soft to mechanically feed with reliability.

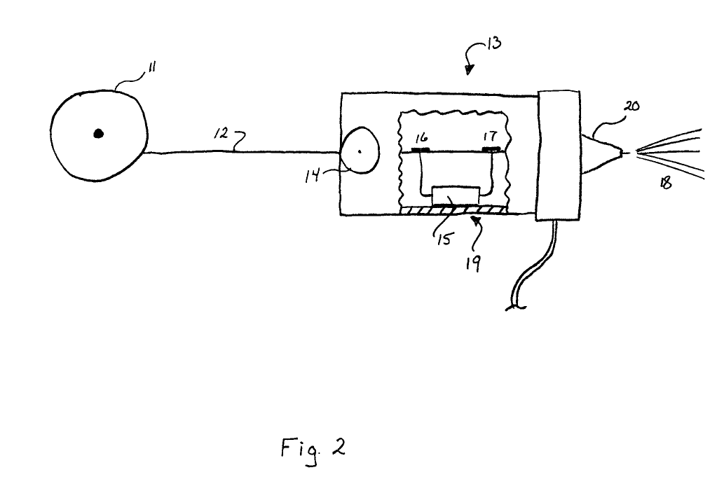

Another operational efficiency factor is heat loss from the wire 2 that occurs if the wire 2 is preheated at some point away from thermal spray device 3 as in the configuration in FIG. 1. For materials such as copper these losses can be significant and limit thermal efficiency as well as the temperature of the wire that can be affectively achieved. In addition, most combustion guns use cool air at the entry point of the wire into the combustion chamber. This air will result in additional cooling of the wire and a subsequent drop in the wire temperature. These losses can be reduced by making the heating section 9 integral to the housing of thermal spray device 3. This configuration provides closer proximity of the heating section 9 to the combustion chamber 10 and may further reduce heat loss because the enclosure of the housing will retain heat. Even greater efficiencies can be achieved by heating the wire after it passes the drive rollers—as will be described in connection with the embodiment shown in FIG. 2. The configuration of FIG. 1 can be easily retrofit onto conventional thermal spray guns.

FIG. 2 shows another embodiment of a wire combustion gun system according to the present invention. In general, a wire feed stock source 11 is provided from which a wire 12 is fed past a heating section 19 into a thermal spray device 13. As is the case with the embodiment of FIG. 1, the wire 12 may be any material suitable for processing through a combustion wire thermal spray device. In FIG. 2, the thermal spray device 13 includes a wire feed mechanism 14 to receive the wire 12 and feed the wire past the heating section 19 and into the combustion chamber 20 of the thermal spray device 13. The heat of burning gas in the combustion chamber 20 softens the leading tip of the wire 12. A high velocity stream of blast gas is directed from the air cap of combustion chamber 20 against the softened leading tip, atomizing the wire 12 as it melts to form particles 18. The atomized particles 18 are propelled from the gun, by the stream of blast gas, onto a substrate to form a coating. The heating section 19 is shown as a resistive heating device with a power supply 15 and electrical contacts 16 and 17 touching the wire 12 at two points after the wire is fed past a wire feeder 14 of the thermal spray device 13. Other heating means, alone or in combination, may also be used within heating section 19. Wire feeder 14 may include one or more rollers or other conventional means to grip and advance the wire 12.

The configuration on FIG. 2 allows the wire 12 to be heated up to the melting temperature of the wire material. In this embodiment, the heat loss in the preheated wire 12 is minimized because of several factors. First, the close proximity of the heat source 19 to the combustion chamber 20 reduces the time that the wire 12 has to cool. Second, the radiated heat from the combustion chamber helps limit cooling. Third, the housing of the thermal spray device 3 retains heat in the preheating area, including the portion of the wire 12 travel immediately following heating section 19.

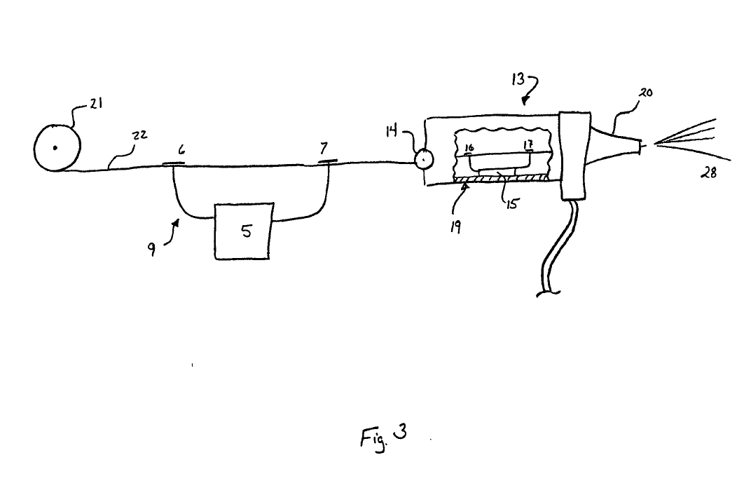

FIG. 3 shows another embodiment of the invention. In this embodiment, a wire feed stock source 21 is provided from which a wire 22 is fed past two separate heating sections into a thermal spray device 13. A first heating section 9 is located upstream from the thermal spray device, and in particular, before the wire encounters a wire feeder 14. A second heating section 19 is located downstream from the wire feeder 14 and prior to a combustion chamber 20 of the thermal spray device 13. A high velocity stream of blast gas is directed from the air cap of combustion chamber 20 against the softened leading tip of wire 22, atomizing the wire 22 in the form of particles 28. The atomized particles 28 are propelled from the gun onto a substrate to form a coating. As is the case with the embodiment of FIG. 1, the wire 22 may be any material suitable for processing through a combustion wire thermal spray device. The use of a heating source both upstream and downstream of the wire feeder 14 allows the wire to be pre-heated up to a point below the melting temperature at which the wire is firm enough to pass through the wire feeder 14, and then pre-heated up to a higher temperature (at or near the wire melting point) prior to entering the combustion chamber. Heating sections 9 and 19 may be of the same type or of different types.

As discussed above, the speed at which the combustion process occurs is a limiting factor in the rate of application of a thermal coating. Similarly, the rate of increase in wire temperature can also become a limiting factor. In the embodiment of FIG. 2, the area of pre-heat exposure (which may be governed, for example, by the size of the thermal spray device) and the feed rate will impact how much wire pre-heating can be achieved by a given power source. The embodiment of FIG. 3, allows for a reduction in the energy demands of the downstream heating section.

In operation, the device according to the configuration of FIG. 1 of the present invention is used as follows: The wire feed source 1 of the wire 2 suitable for use in a thermal spray device is provided. The wire 2 is fed from the wire feed source 1 through heating section 9, which may or may not be operational at the time, and then connected to the wire feeder 4 of thermal spray device 3. If the heating section 9 of the device is not operational prior to attachment of the wire 2 to the wire feeder 4, initial feed rates of the thermal spray device will be the same as that of conventional combustion spray guns until the first section of the pre-heated wire 2 reaches the combustion chamber 10. Once the pre-heated wire 2 reaches the combustion chamber 10, the wire 2 is atomized and propelled from the gun 3 onto a substrate to form a coating. Because this first pre-heated wire section 2 is closer to the wire melting point than the previous sections, the atomization process will require less energy to complete and allow for a subsequently faster wire feed rate. Operational efficiency will continue to improve as the improved feed rates reduce the amount of heat loss in following sections of wire 2 before the wire 2 reaches combustion chamber 10. These improvements will continue throughout the operation until equilibrium in the wire feed process is achieved.

The combustion wire gun and heater as depicted in FIG. 1 was tested under lab conditions. The wire feed stock material was copper with the following process properties:

| Diameter of copper wire: | ⅛″ | (0.318 cm) |
|---|---|---|
| Density of copper wire: | 8.96 | g/cc |
| Melting point of copper wire: | 1083 | degrees C. |
| Specific heat of copper wire: | 0.000365 | Btu/g*C |
| Latent heat of fusion of copper wire: | 0.195 | Btu/g |
| Heat of combustion, Acetylene: | 1470 | Btu/cu ft |

First, a typical combustion wire process parameter for spraying copper with acetylene was used to spray the wire feedstock without preheating the wire. The maximum feed rate of wire that was achieved with the wire melting completely as it exited the front of the gun was determined to be 151 g/min. Determination of the maximum wire feed was done by observing the length of the un-melted wire tip extending out the front of the gun. An un-melted tip of 0.375″ was considered the maximum wire speed. The gun produced 66,150 Btu/hr using a standard acetylene spray parameter for copper.

Next, the same conditions as the previous test were repeated with the wire heated to an estimated temperature of 566 degrees C. (approximately half the melting point of copper) measured at the point prior to the wire entering the combustion wire gun. The maximum feed rate of wire that was achieved with the un-melted wire tip extending the same 0.375″ as it exited the front of the gun was determined to be 190 g/min. The result was a 26% increase in wire feed rate without any increase in gas flow or change in the gun parameters. The amount of energy used to heat the wire was 12,768 Btu's/hr. From the first test, 66,150 Btu/hr was required to spray 151 g/min, from the second test 78,918 Btu/hr was required to spray 190 g/min—an increase in operating efficiency for the overall process of 5%.

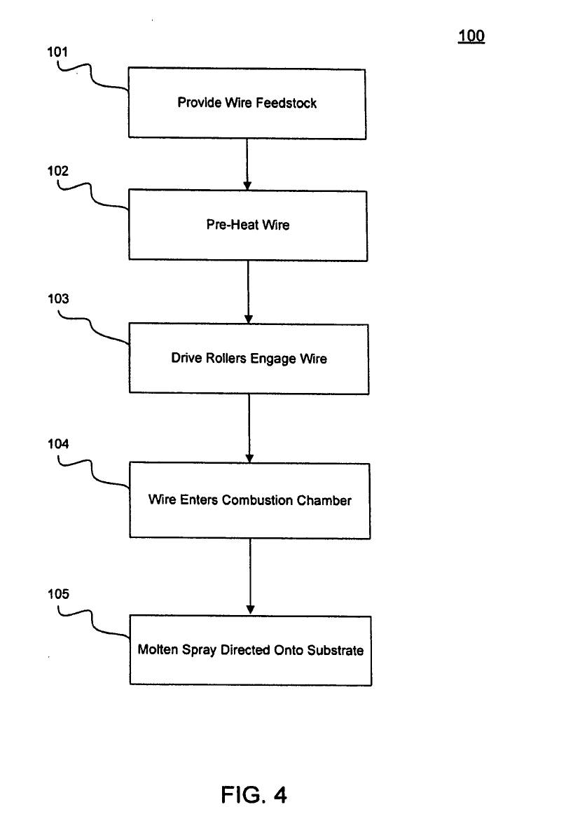

FIG. 4 provides a flow chart of a method 100 of producing a coating with a thermal spray gun that includes a wire feeder and a combustion chamber. The method begins with step 101 where a wire feedstock of heat-fusible material, such as copper, bronze, aluminum, tin, zinc, or any other material suitable for processing through a combustion wire thermal spray device is provided. Next, proceeding to step 102, the wire feedstock is heated to a temperature above ambient conditions. For example, in step 102, the wire may be heated to the temperature closest to the melting temperature of the wire material at which the wire can still be passed through the wire feeder of the thermal spray device (i.e., the optimal pre-feed temperature). However, heating the wire to any temperature above ambient conditions will improve the operating efficiency of the thermal spray process. In step 103, the pre-heated wire is engaged by the wire feeder of the thermal spray device. Depending upon the time between step 102 and step 103, the temperature to which the wire is heated in step 102, may actually exceed the optimal pre-feed temperature so that the cooling wire may approach the optimal pre-feed temperature at the time of step 103. In step 104, the wire feeder of the thermal spray device is used to feed the wire feedstock into the combustion chamber to a point where a wire tip is formed where material is melted and atomized such that a spray stream containing the heat fusible material is propelled from the wire tip. A final step 105, may include directing the spray stream toward a substrate to produce a coating thereon.

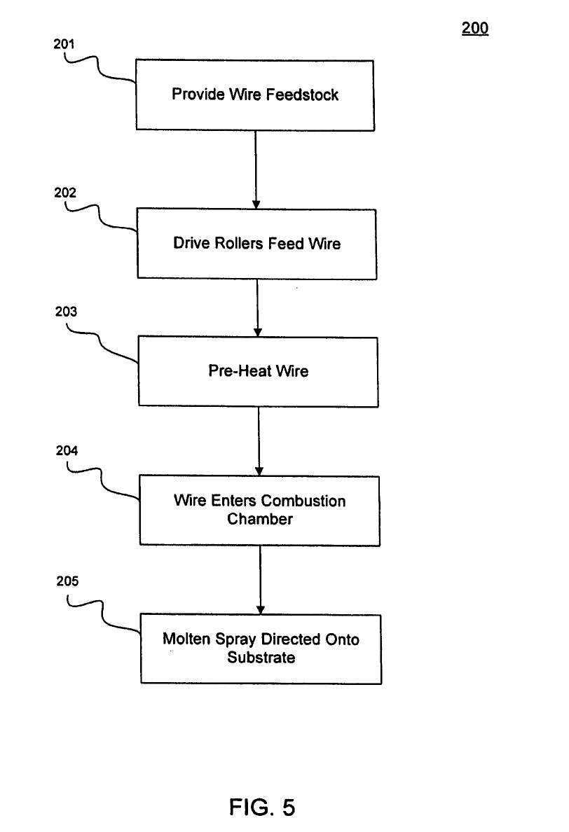

FIG. 5 provides a flow chart illustrating another embodiment of a method 200 for producing a coating with a thermal device that includes a wire feeder and a combustion chamber. As with the previous method, this method begins at step 201 whereby a wire feedstock of heat-fusible material is provided. Next, proceeding to step 202, the wire is engaged by the wire feeder of the thermal spray gun. In step 203, the wire feedstock is heated to a temperature above ambient conditions. For example, in step 203, the wire may be heated as close as possible to the melting temperature of the wire material. However, heating the wire to any temperature above ambient conditions will improve the operating efficiency of the thermal spray process. In step 204, the wire feeder of the thermal spray gun forces the pre-heated wire feedstock into the combustion chamber to a point where a wire tip is formed where material is melted and atomized such that a spray stream containing the heat fusible material is propelled from the wire tip. A final step 205, may include directing the spray stream toward a substrate to produce a coating thereon.

In one embodiment of the invention, the methods described in FIGS. 4 and 5 may be combined into a single method to achieve the efficiencies of both of these previous methods. In this combined method, a wire feed stock source is provided from which a wire is fed past a two separate heating sections into a thermal spray device. Before reaching the wire feeder of the thermal spray gun, the wire is heated to a temperature above ambient conditions, preferably the optimal pre-feed temperature. After passing through the wire feeder the wire feedstock is again heated, preferably to the melting temperature of the wire material.

While exemplary embodiments of the invention have been shown and described herein, it will be obvious to those skilled in the art that such embodiments are provided by way of example only. Numerous insubstantial variations, changes, and substitutions will now be apparent to those skilled in the art without departing from the scope of the invention disclosed herein by the Applicants. Accordingly, it is intended that the invention be limited only by the spirit and scope of the claims, as they will be allowed.

1. A method of producing a coating with a thermal spray device having a wire feeder and a combustion chamber, the method comprising the following steps:
providing a wire feedstock with wire of heat-fusible material;
preheating the wire from the wire feedstock to a temperature between about half the melting point of the heat-fusible material and the optimal pre-feed temperature of the wire;
using the wire feeder to feed the preheated wire into the thermal spray device;
feeding the preheated wire into the combustion chamber to a point where the leading tip of the wire is melted and atomized such that a spray stream containing the heat-fusible material is propelled from the wire tip; and
directing the spray stream toward a substrate to produce a coating thereon.

2. (canceled)

3. The method of claim 1, wherein the wire is preheated by one or more of induction heating, resistive heating, conductive heating, and radiation heating.

4. (canceled)

5. The method of claim 1, wherein the first heating step raises the temperature of the wire so as to achieve the optimal pre-feed temperature at the time the step of using the wire feeder occurs.

6. The method of claim 1, further comprising a second preheating step of heating the wire after the step of using the wire feeder and prior to entry of the wire into the combustion chamber.

7. The method of claim 6, wherein the second heating step raises the temperature of the wire to a temperature above the optimal pre-feed temperature up to and including the melting point of the heat-fusible material.

8. The method of claim 1, wherein the wire is fed axially through the combustion chamber.

9. (canceled)

10. The method of claim 1, wherein the heat-fusible material is predominantly copper, aluminum, tin, or zinc.

11. A wire combustion thermal spray device, comprising:
nozzle means for generating an annular heating flame;
heating means for pre-heating a wire of heat-fusible material to a temperature above about half the melting point of said heat-fusible material;
feeding means for feeding the pre-heated wire axially from the nozzle within the heating flame such that the wire is melted at a tip of the wire by the heating flame; and
atomizing means for atomizing the melted material from the wire tip and propelling the atomized material in a spray stream.

12. The spray gun of claim 11, wherein the temperature above about half the melting point of said heat-fusible material is a temperature up to and including the melting point of the heat-fusible material.

13. The spray gun of claim 11, wherein the heating means is one or more of induction heating, resistive heating, conductive heating, and radiation heating.

14. (canceled)

15. The spray gun of claim 11, wherein said heating means raises the temperature of the wire so as to achieve the optimal pre-feed temperature at the time the heated wire reaches the feeding means.

16. The spray gun of claim 11, further comprising a second heating means, wherein the second heating means is located downstream of said feeding means.

17. The spray gun of claim 16, wherein the second heating means raises the temperature of the wire to a temperature above an optimal pre-feed temperature up to and including the melting temperature of the heat-fusible material.

18. (canceled)

19. (canceled)

20. (canceled)

21. A method of delivering heated wire feedstock to a combustion chamber of a thermal spray gun, comprising the following steps:
providing a wire feedstock with wire of heat-fusible material;
first preheating the wire from the wire feedstock to a temperature above ambient conditions;
following said preheating step, feeding the wire into the thermal spray gun;
following said feeding step, further preheating the wire prior to entry of the wire into the combustion chamber; and
feeding the preheated wire into the combustion chamber.

22. The method of claim 21, wherein the temperature above ambient conditions is a temperature up to and including the melting point of the heat-fusible material.

23. The method of claim 21, wherein the wire is preheated by one or more of induction heating, resistive heating, conductive heating, and radiation heating.

24. (canceled)

25. The method of claim 21, wherein the first preheating step raises the temperature of the wire so as to achieve the optimal pre-feed temperature at the time the step of feeding the wire into the thermal spray gun occurs.

26. (canceled)

27. The method of claim 21, wherein the further preheating step raises the temperature of the wire to a temperature above ambient conditions up to about the melting point of the heat-fusible material.

28. (canceled)

29. (canceled)

30. The method of claim 21, wherein the heat-fusible material is predominantly copper, aluminum, tin, or zinc.

31. A wire combustion thermal spray system, comprising:
a gun body;
a nozzle mounted on the gun body;
an annular gas cap extending from the nozzle with a passage therethrough defining a combustion chamber;
one or more feed rollers for receiving a leading end of a wire and feeding the leading end axially through the nozzle passage and into the combustion chamber; and
a heater for raising the temperature of a portion of the wire above ambient conditions prior to the portion entering the feed rollers, said heater integrated into said body.

32. The system of claim 31, wherein the temperature above ambient conditions is an optimal pre-feed temperature.

33. The system of claim 31, wherein the heater is one or more of an induction heater, an electric current producing resistive heating, a source of hot gas, and a radiation heater.

34. (canceled)

35. The system of claim 31, wherein heater raises the temperature of the wire so as to achieve an optimal pre-feed temperature at the time the heated wire reaches the feed rollers.

36. The system of claim 31, further comprising a second heater, wherein the second heater is located downstream of the feed rollers.

37. The system of claim 36, wherein the second heater raises the temperature of the wire to a temperature above an optimal pre-feed temperature up to and including the melting temperature of the wire.

38. (canceled)

39. (canceled)

40. (canceled)
